(19) United States
(12) Patent Application Publication
(10) Pub. No.: US 2014/0362982 A1
(43) Pub. Date: Dec. 11, 2014

(54) DATA EXCHANGE METHOD, DEVICE, AND SYSTEM FOR GROUP COMMUNICATION

(71) Applicant: TENCENT TECHNOLOGY (SHENZHEN) COMPANY LIMITED, Shenzhen (CN)

(72) Inventors: BING HAN, Shenzhen (CN); DONGLIN PU, Shenzhen (CN); HUIHAO XING, Shenzhen (CN)

(73) Assignee: TENCENT TECHNOLOGY (SHENZHEN) COMPANY LIMITED, Shenzhen (CN)

(21) Appl. No.: 14/256,963

(22) Filed: Apr. 19, 2014

Related U.S. Application Data
(63) Continuation of application No. PCT/CN2013/090039, filed on Dec. 20, 2013.

(30) Foreign Application Priority Data
Jun. 8, 2013 (CN) 2013102275269

(51) Int. Cl. H04M 3/56

(52) U.S. Cl. CPC H04M 3/56
USPC 379/202.01

(57) ABSTRACT

A method is provided for group communication data exchange. The method includes sending by a business client an identifier of a communication group corresponding to a user group including a first user to a voice service client, and establishing by the voice service client a long connection between the voice service client and a voice service system based on the identifier of the communication group. The method also includes adding by the voice service system the user to a communication group included in the voice service system, and performing by the voice service client data exchange with the voice service system over the long connection for group communication data generated by the communication group.

### CROSS-REFERENCES TO RELATED APPLICATIONS

This application is a continuation application of PCT Patent Application No. PCT/CN2013/090039, filed on Dec. 20, 2013, which claims priority of Chinese Patent Application No. 201310227526.9, filed on Jun. 8, 2013, the entire contents of all of which are incorporated by reference herein.

### FIELD OF THE INVENTION

The present invention generally relates to the field of Internet communication and, more particularly, to a group communication data exchange method, device, and system.

### BACKGROUND

With the rapid development of Internet technologies, there are many Internet-based service businesses providing voice services for users. For example, when a user is using a certain business and the user using the business can form a user group with one or more other users, the user can, during the use of the business, use the voice service provided by the business to conduct group communication with the other users in the user group.

Currently, the user often uses the business through a business client. When the user wants to conduct group communications with the other users in the user group during the use of the business, the user submits a group communication command to the business client. The business client receives the group communication command, and adds the user to a communication group corresponding to the user group in a business system. Further, the business client exchanges the group communication data generated by the communication group with the business system, achieving the group communication between the user and the other users in the user group.

However, because the user uses the business client to conduct group communications, when the user exists from the business client, the group communication data exchange between the business clients and the business system is also interrupted. Thus, the user cannot continue the group communication with the other users in the user group.

The disclosed method and system are directed to solve one or more problems set forth above and other problems.

### BRIEF SUMMARY OF THE DISCLOSURE

One aspect of the present disclosure includes a method for group communication data exchange. The method includes sending by a business client an identifier of a communication group corresponding to a user group including a first user to a voice service client, and establishing by the voice service client a long connection between the voice service client and a voice service system based on the identifier of the communication group. The method also includes adding by the voice service system the user to a communication group included in the voice service system, and performing by the voice service client data exchange with the voice service system over the long connection for group communication data generated by the communication group.

Another aspect of the present disclosure includes a method for group communication data exchange. The method includes establishing a long connection with a voice service client corresponding to a user, and receiving through the long connection an identifier of a communication group and an identifier of the user sent from the voice service client. The identifier of the communication group is the identifier of the communication group sent by the business client and the communication group is a communication group corresponds to a user group where the user belongs. The method also includes adding the user to the communication group based on the identifier of the communication group and the identifier of the user. Further, the method includes performing data exchange with the voice service client through the long connection with group communication data produced by the communication group.

Another aspect of the present disclosure includes a group communication data exchange system. The system includes a business client and a voice service client. The business client is configured to send an identifier of a communication group corresponding to a user group including a first user to the voice service client. The voice service client is configured to, based on the identifier of the communication group, establish a long connection between the voice service client and a voice service system and to add the user to a communication group included in a voice service system. The voice service client is further configured to perform data exchange with the voice service system over the long connection with group communication data generated by the communication group.

Another aspect of the present disclosure includes a group communication data exchange device. The group communication data exchange device includes an establishing module, a first receiving module, and a data exchange module. The establishing module is configured to establish a long connection with a voice service client corresponding to a user; an adding module. The first receiving module is configured to receive through the long connection an identifier of a communication group and an identifier of the user sent from the voice service client. The identifier of the communication group is the identifier of the communication group sent by the business client and the communication group is a communication group corresponds to a user group where the user belongs. The adding module is configured to, based on the identifier of the communication group and the identifier of the user, add the user to the communication group. Further, the data exchange module is configured to perform data exchange with the voice service client through the long connection with group communication data produced by the communication group.

Other aspects of the present disclosure can be understood by those skilled in the art in light of the description, the claims, and the drawings of the present disclosure.

### BRIEF DESCRIPTION OF THE DRAWINGS

FIG. 1 illustrates an exemplary group communication data exchange process consistent with the disclosed embodiments;

FIG. 2 illustrates another exemplary group communication data exchange process consistent with the disclosed embodiments;

FIG. 3 illustrates an exemplary display interface consistent with the disclosed embodiments;

FIG. 4 illustrates another exemplary display interface consistent with the disclosed embodiments

FIG. 5 illustrates an exemplary structural diagram of a group communication data exchange process consistent with the disclosed embodiments;

FIG. 6 illustrates another exemplary group communication data exchange process consistent with the disclosed embodiments;

FIG. 7 illustrates another exemplary structural diagram of a group communication data exchange process consistent with the disclosed embodiments;

FIG. 8 illustrates another exemplary group communication data exchange process consistent with the disclosed embodiments;

FIG. 9 illustrates an exemplary group communication data exchange system consistent with the disclosed embodiments;

FIG. 10 illustrates an exemplary group communication data exchange device consistent with the disclosed embodiments;

FIG. 11 illustrates an exemplary operating environment incorporating certain disclosed embodiments; and

FIG. 12 illustrates a block diagram of an exemplary computer system consistent with the disclosed embodiments.

### DETAILED DESCRIPTION

Reference will now be made in detail to exemplary embodiments of the invention, which are illustrated in the accompanying drawings.

FIG. 11 illustrates an exemplary operating environment 1100 incorporating certain disclosed embodiments. As shown in FIG. 11, environment 1100 may include a server 1102, a terminal 1104, a terminal 1106, and network 1108. The network 1108 may include any appropriate type of communication network for providing network connections to the terminals 1104 and 1104 and the server 1102. For example, network 1108 may include the Wi-Fi network, cellular network, or other types of computer networks or telecommunication networks, either wired or wireless. In one embodiment, network 1108 is the Internet.

A server, as used herein, may refer to one or more server computers configured to provide certain server functionalities to provide certain services. A server may also include one or more processors to execute computer programs in parallel. Although only one server is shown, any number of servers can be included. The server 1102 may be operated in a cloud or non-cloud computing environment.

Terminal 1104 or terminal 1106 may include any appropriate type of computing devices, such as personal computers (PCs), mobile phones, smart phones, tablets, notebook computers, or any type of computing platform.

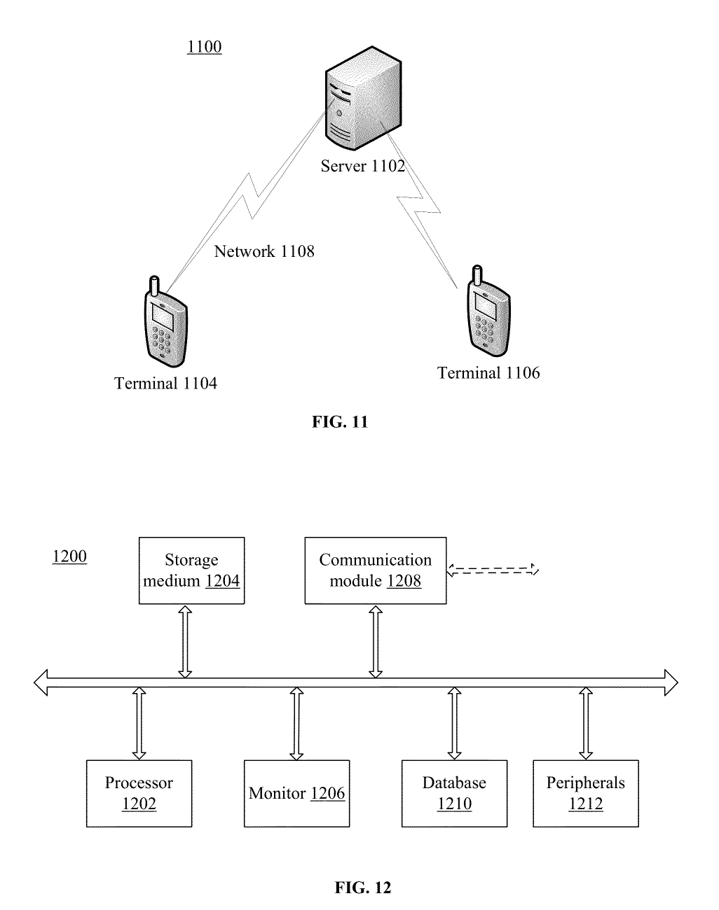

Terminal 1104/1106 and/or server 1102 may be implemented on any appropriate computing platform. FIG. 12 illustrates a block diagram of an exemplary computer system 1200 capable of implementing terminal 1104 and/or server 1102.

As shown in FIG. 12, computer system 1200 may include a processor 1202, a storage medium 1204, a monitor 1206, a communication module 1208, a database 1210, and peripherals 1212. Certain devices may be omitted and other devices may be included.

Processor 1202 may include any appropriate processor or processors. Further, processor 1202 can include multiple cores for multi-thread or parallel processing. Storage medium 1204 may include memory modules, such as Read-only memory (ROM), Random Access Memory (RAM), flash memory modules, and erasable and rewritable memory, and mass storages, such as CD-ROM, U-disk, and hard disk, etc. Storage medium 1204 may store computer programs for implementing various processes, when executed by processor 1202.

Further, peripherals 1212 may include I/O devices such as keyboard and mouse, and communication module 1208 may include network devices for establishing connections through the communication network. Database 1210 may include one or more databases for storing certain data and for performing certain operations on the stored data, such as database searching.

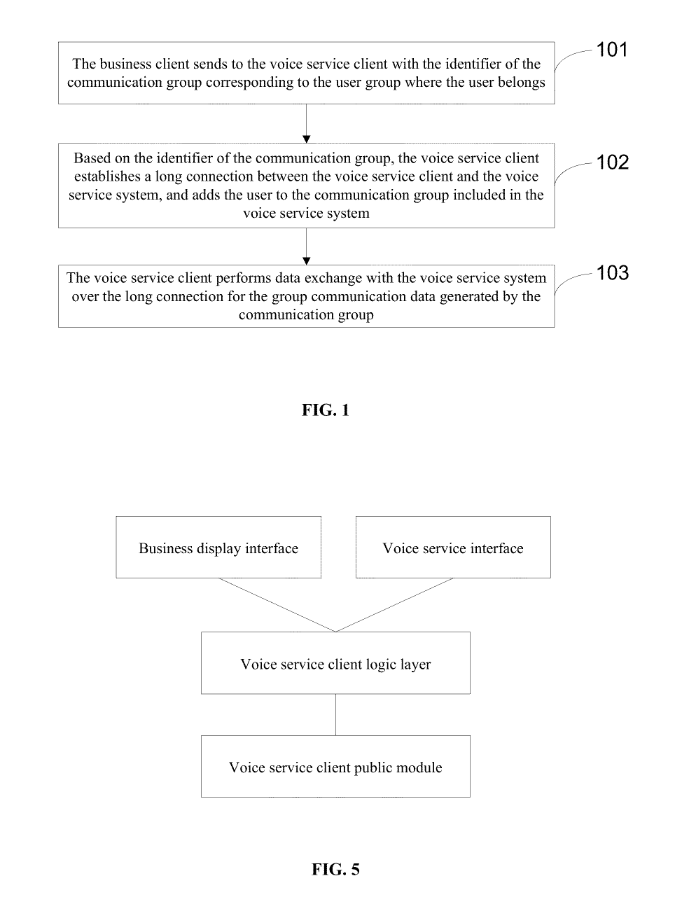

In operation, terminal 1104/1106 and/or server 1102 may provide group communication functionalities to a user of a terminal with other users of other terminals. The terminal may have one or more business clients for providing group communication data exchange. A client, as used herein, may refer to a software program (or a combination of software and hardware) running on the terminal to provide certain functions associate with a certain business or service. FIG. 1 illustrates an exemplary group communication data exchange process for a user of a terminal consistent with the disclosed embodiments.

As shown in FIG. 1, the group communication data exchange process may include the following steps.

Step 101: the business client sends to the voice service client with the identifier of the communication group corresponding to the user group where the user belongs.

Step 102: based on the identifier of the communication group, the voice service client establishes a long connection between the voice service client and the voice service system, and adds the user to the communication group included in the voice service system.

Step 103: the voice service client performs data exchange with the voice service system over the long connection for the group communication data generated by the communication group.

Thus, according to the disclosed embodiments, when the user requests group communication, the business client sends to the voice service client with the identifier of the communication group corresponding to the user group where the user belongs. The voice service client establishes a long connection between the voice service client and the voice service system, and adds the user to the communication group included in the voice service system. The voice service client performs data exchange with the voice service system over the long connection for the group communication data generated by the communication group. Because the business client and the voice service client are two independent clients, even after the user exits the business client, the user can still communicate with other users in the communication group through the voice service client.

FIG. 2 illustrates another exemplary group communication data exchange process consistent with the disclosed embodiments. A first user uses the business (i.e., business services) via a first business client and, during the use of the business, forms a temporary user group with other users. The user relationship in the temporary user group is not a fixed user relationship, and the temporary user group disappears when the first user exits the temporary user group. The first user conducts group communication (e.g., group chat or group calls) with the other users in the temporary user group while using the business through the first business client.

As shown in FIG. 2, the group communication data exchange process may include the following steps.

Step 201: a first business client sends a temporary communication request message to a first voice service client.

Specifically, when a first user needs to conduct group communication with other users in a temporary user group, the first business client receives a temporary communication command submitted by the first user, and establishes a communication channel between the first business client and a first voice service client. Further, using the communication channel between the first business client and a first voice service client, the first business client sends a temporary communication request message to the first voice service client.

In certain embodiments, the first business client may have a business display interface containing a temporary communications command button. When the first user needs to conduct group communication with other users in the temporary user group, the first user can submit the temporary communication command to the first business client by pressing or clicking on the temporary communications command button.

The first voice service client may be started in various ways. For example, two ways may be used to start the first voice service client. First, when the first business client receives the temporary communication command submitted by the first user, the first business client starts the first voice service client. Second, when the first user needs to conduct group communication with other users in the temporary user group, the first user starts the first voice service client.

In certain embodiments, the business may be computer gaming, and the business client may be a gaming client.

Step 202: the first voice service client receives the temporary communication request message, establishes a long connection (or persistent connection) between the first voice service client and a voice service system, and sends the temporary communications request message to the voice service system via the long connection. The temporary communication request message includes an identifier of the first user, and other types of connection may also used.

The first voice service client stores in advance the identifier of the first user. The voice service system may include a voice server and a communication group server, and the communication group server may include a plurality of idle temporary communication groups.

Specifically, the first voice service client receives the temporary communication request message, establishes the long connection (or persistent connection) between the first voice service client and the voice server, and sends the temporary communications request message to the voice server through the long connection. The temporary communication request message includes the identifier of the first user.

Step 203: the voice service system receives the temporary communication request message, assigns a temporary communication group for the temporary user group of the first user, and adds the first user to the temporary communication group. Further, voice service system sends the identifier of the temporary communication group to the first voice service client.

Specifically, the voice service system receives the temporary communication request message through the long connection between the voice service system and the first voice service client, and assigns a temporary communication group for the temporary user group of the first user. Further, the voice service system adds the first user to the temporary communication group, and sends the identifier of the temporary communication group to the first voice service client through the long connection between the voice service system and the first voice service client.

When adding the first user to the temporary communication group, the voice service system may add the identifier of the first user to the temporary communication group.

Further, more particularly, the voice server included in the voice service system receives the temporary communication request message through the long connection between the voice server and the first voice service client, and assigns the temporary communication group for the temporary user group of the first user from the plurality of idle temporary communication groups in the communication group server. Further, the voice server adds the first user to the temporary communication group, and sends the identifier of the temporary communication group to the first voice service client through the long connection between the voice server and the first voice service client.

In one embodiment, the temporary communication group is a temporary chat room.

Step 204: the first voice service client receives the identifier of the temporary communication group, and sends the identifier of the temporary communication group to the first business client.

Specifically, the first voice service client receives the identifier of the temporary communication group through the long connection between the first voice service client and the voice server, and sends the identifier of the temporary communication group to the first business client through the communication channel between the first voice service client and the first business client.

Step 205: the first business client receives the identifier of the temporary communication group, and sends the identifier of the temporary communication group and the identifier of the temporary user group of the first user to a business server.

Step 206: the business server receives the identifier of the temporary communication group and the identifier of the temporary user group of the first user. Based on the identifier of the temporary user group, the business server sends an invitation request message to a second business client corresponding to a second user in the temporary user group. The invitation request message includes the identifier of the temporary communication group, and the second user is a user in the temporary user group different from the first user.

Specifically, after the business server receives the identifier of the temporary communication group and the identifier of the temporary user group of the first user, based on the identifier of the temporary user group and from pre-stored corresponding relationships between user identifiers and temporary user group identifiers, the business server obtains the identifier of the second user in the temporary user group. Further, based on the identifier of the second user in the temporary user group, the business server sends an invitation request message to the second business client corresponding to the second user in the temporary user group. The invitation request message includes the identifier of the temporary communication group. The pre-stored corresponding relationships between user identifiers and temporary user group identifiers may be stored on the business server in advance.

Step 207: the second business client receives the invitation request message, and sends the identifier of the temporary communication group contained in the invitation request message to the second voice service client.

Specifically, after the second business client receives the invitation request message, if the second user accepts the invitation request send by the business server and the second business client receives the accept command submitted by the second user, the second business client establishes a communication channel between the second business client and the second voice service client, and sends the identifier of the temporary communication group contained in the invitation request message to the second voice service client through the communication channel.

The second voice service client may be started in various ways. For example, two ways may be used to start the second voice service client. First, if the second user accepts the invitation request sent by the business server and the second business client receives the accept command submitted by the second user, the second business client starts the second voice service client. Second, the second user can start the second voice service client.

When the second voice service client is started by the second business client, if the second user does not accept the invitation request sent by the business server, the second user can submit a reject command to the second business client, and the second business client does not start the second voice service client.

Step 208: the second voice service client receives the identifier of the temporary communication group, establishes a long connection between the second voice service client and the voice service system, and sends the identifier of the temporary communication group and the identifier of the second user to the voice service system.

Specifically, the second voice service client receives the identifier of the temporary communication group through the communication channel between the second voice service client and the second business client, establishes the long connection between the second voice service client and the voice service system, and sends the identifier of the temporary communication group and the identifier of the second user to the voice service system through the long connection. The identifier of the second user may be stored on the second voice service client in advance.

Step 209: the voice service system receives the identifier of the temporary communication group and the identifier of the second user and, based on the identifier of the temporary communication group, adds the second user to the temporary communication group.

Specifically, the voice server receives the identifier of the temporary communication group and the identifier of the second user through the long connection between the voice server and the second voice service client, and adds the second user to the temporary communication group according to the identifier of the temporary communication group.

When the voice service system adds the second user to the temporary communication group, the voice service system adds the identifier of the second user in the temporary communication group.

Further, the voice service system may also send the identifier of each user in the temporary communication group to the voice service client corresponding to each user in the temporary communication group.

For example, the temporary communication group received by the first voice service client from the voice service system includes the identifier of each user in the temporary communication group. Through the communication channel between the first voice service client and the first business client, the first voice service client sends the identifier of each user in the temporary communication group to the first business client. The first business client receives the identifier of each user in the temporary communication group and, based on the identifier of each user in the temporary communication group, displays account information of each user in the temporary communication group on the business display interface of the first business client.

The account information of a user may include any appropriate information. For example, the user account information may include the user's identifier and/or the user's nickname, or may include the user's avatar or other images. When the user account information includes the identifier of the user, the first business client directly displays the identifier of each user in the temporary communication group on the business display interface of the first business client. When the user account information includes the nickname of the user, the first business client obtains the account information of each user in the temporary communication group from pre-stored corresponding relationship between the user identifier and the account information, based on the identifier of each user in the temporary communication group, and further displays the account information of each user in the temporary communication group on the business display interface of the first business client.

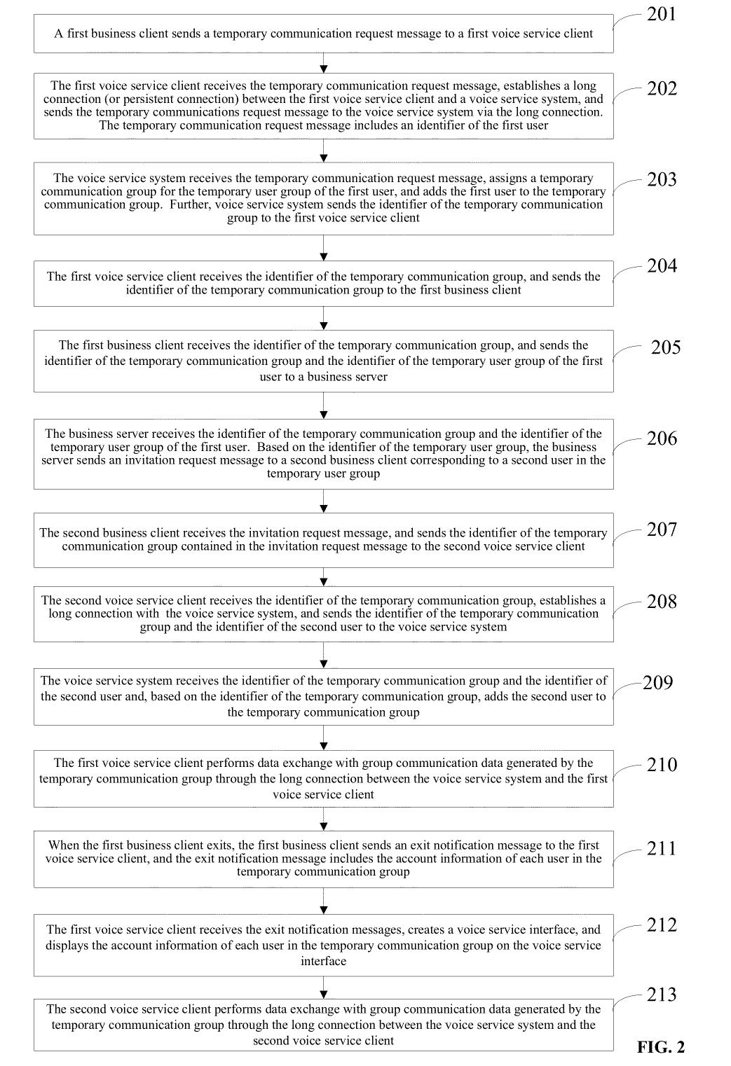

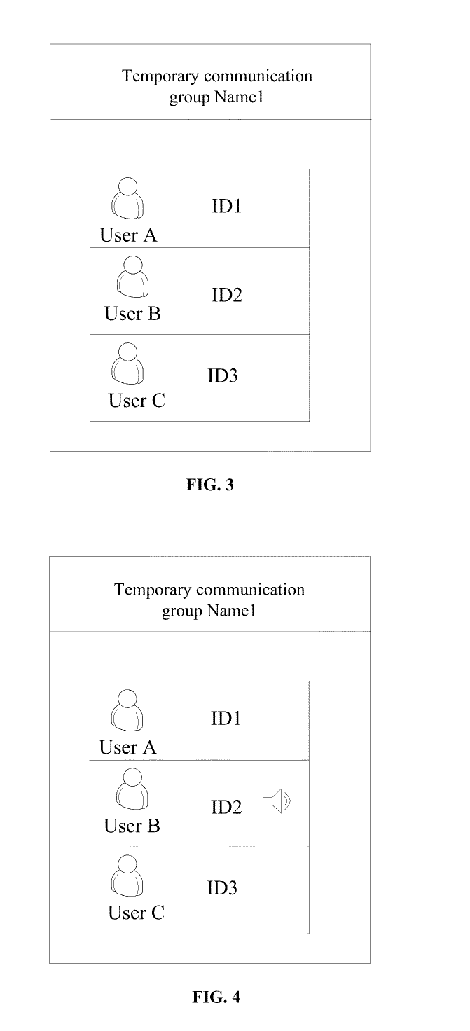

For example, the identifier of the temporary communication group is ‘Name1’, and the temporary communications group includes user A, user B, and user C. The identifier of user A is ‘ID1’, the identifier of user B is ‘ID2’, and the identifier of user C is ‘ID3’. Another user D has an identifier as ‘ID4’. If the user account information includes the identifier of the user, as shown in FIG. 3, the first business client displays the account information of each user in the temporary communication group on its business display interface (e.g., user A, user B, and user C). That is, the identifier of the temporary communication group, each user identifier and each user name (along with an avatar) are displayed on the display interface.

Further, similarly, a second business client corresponding to a second user (in addition to the first user) in the temporary communication group may also display the account information of each user in the temporary communication group on its business display interface. The detailed descriptions are omitted herein.

Step 210: the first voice service client performs data exchange with group communication data generated by the temporary communication group through the long connection between the voice service system and the first voice service client.

The group communication data generated by the temporary communication group may include voice signals from the first user received by the first voice service client and the first voice data created based on the first user's voice signals. Or the group communication data may also include voice signals from the second user in the temporary communication group received by the second voice service client and the second voice data created based on the second user's voice signals.

When the first user speaks, the first voice service client receives the voice signals generated by the first user's speech, and converts the speech (voice signal) into the first voice data. The first voice service client further adds the identifier (ID) of the first user in the first voice data, and sends the first voice data to the voice service system through the long connection between the voice service system and the first voice service client.

The voice service system receives the first voice data, and extracts the ID of the first user from the first user voice data. The voice service system also obtains the temporary communication group of the first user based on the ID of the first user, and broadcasts the first voice data to the voice service clients corresponding to the other users in the temporary communication group except the first user. For example, the voice service system broadcasts the first voice data to the second voice service client corresponding to the second user in the temporary communication group, and the second voice service client plays back the first voice data.

When the second user speaks, the second voice service client receives the voice signals generated by the second user's speech, and converts the speech (voice signal) into the second voice data. The second voice service client further adds the identifier (ID) of the second user in the second voice data, and sends the second voice data to the voice service system through the long connection between the voice service system and the second voice service client.

The voice service system receives the second voice data, and extracts the ID of the second user from the second user voice data. The voice service system also obtains the temporary communication group of the second user based on the ID of the second user, and broadcasts the second voice data to the voice service clients corresponding to the other users in the temporary communication group except the second user. For example, the voice service system broadcasts the second voice data to the first voice service client corresponding to the first user in the temporary communication group, and the first voice service client plays back the second voice data.

The first voice service client may receive the second voice data through the long connection between the voice service system and the first voice service client, and plays back according to the second voice data.

Further, the first voice service client extracts the ID of the second user from the received second voice data, and sends the ID of the second user to the first business client through the communication channel between the first voice service client and the first business client.

After receiving the ID of the second user, the first business client identifies or marks the account information of the second user on the business display interface. For example, as shown in FIG. 4, if the extracted second user ID is the identifier of the user B, the first business client displays a speaker symbol on the position of the second user's account information on its business display interface, such that the account information of the user B is identified.

Step 211: when the first business client exits, the first business client sends an exit notification message to the first voice service client, and the exit notification message includes the account information of each user in the temporary communication group.

Step 212: the first voice service client receives the exit notification messages, creates a voice service interface, and displays the account information of each user in the temporary communication group on the voice service interface.

Step 213: the second voice service client performs data exchange with group communication data generated by the temporary communication group through the long connection between the voice service system and the second voice service client.

The group communication data generated by the temporary communication group may include the voice signal from the second user received by the second voice service client and the second voice data created based on the second user's voice signal. Or the group communication data may also include the voice signal from another user (other than the second user and the exited first user) in the temporary communication group received by another voice service client and the voice data created based on the another user's voice signal.

When the second user speaks, the second voice service client receives the voice signals generated by the second user's speech, and converts the speech (voice signal) into the second voice data. The second voice service client further adds the identifier (ID) of the second user in the second voice data, and sends the second voice data to the voice service system through the long connection between the voice service system and the second voice service client.

The voice service system receives the second voice data, and extracts the ID of the second user from the second user voice data. The voice service system also obtains the temporary communication group of the second user based on the ID of the second user, and broadcasts the second voice data to the voice service clients corresponding to the other users in the temporary communication group except the second user (and the exited first user). For example, the voice service system broadcasts the second voice data to a third voice service client corresponding to a third user in the temporary communication group, and the third voice service client plays back the second voice data.

When the third user speaks, the third voice service client receives the voice signals generated by the third user's speech, and converts the speech (voice signal) into the third voice data. The third voice service client further adds the identifier (ID) of the third user in the third voice data, and sends the third voice data to the voice service system through the long connection between the voice service system and the third voice service client.

The voice service system receives the third voice data, and extracts the ID of the third user from the third user voice data. The voice service system also obtains the temporary communication group of the third user based on the ID of the third user, and broadcasts the third voice data to the voice service clients corresponding to the other users in the temporary communication group except the third user. For example, the voice service system broadcasts the third voice data to the second voice service client corresponding to the second user in the temporary communication group, and the second voice service client plays back the third voice data.

Further, when the second business client exits, the second business client sends an exit notification message to the second voice service client, and the exit notification message carries account information of each user still included in the temporary communication group. The second voice service client receives the exit notification message, creates a voice service interface, and displays each user's account information in the temporary communication group on the voice service interface.

FIG. 5 illustrates a corresponding group communication data exchange structure. As shown in FIG. 5, the structure includes a voice service client public module, a voice service client logic layer, a business display interface, and a voice service interface.

The voice service client public module receives the ID of each user in the communication group sent by the voice service system. The voice service client logic layer determines whether the business client has exited. When the voice service client logic layer determines that the business client did not exit, the ID of each user in the communication group is sent to the business client, such that the business client displays the ID of each user in the communication group on its business display interface. On the other hand, when the voice service client logic layer determines that the business client exited, the ID of each user in the communication group is displayed on the voice service interface.

Meanwhile, when the voice service client public module receives group communication data, the voice service client logic layer determines whether the business client has exited. When the voice service client logic layer determines that the business client did not exit, the group communication data is sent to the business client, such that the business client extracts the ID of user generating the group communication data and identifies the ID of the user on its business display interface. On the other hand, when the voice service client logic layer determines that the business client exited, the voice service client logic layer extracts the ID of user generating the communication data and identifies the user on the voice service interface.

Further, when the business client exits, the voice service client logic layer obtains the ID of each user in the communication group from the business display interface, and displays the ID of each user in the communication group on the voice service interface.

Thus, according to the disclosed embodiments, when a user starts a group communication, the business client sends the ID of the temporary communication group corresponding to the temporary user group where the user belongs to the voice service client. The voice service client establishes a long connection between the voice service client and the voice service system, and the user is added the temporary communication group in the voice service system. The voice service client then performs data exchange with the group communication data produced by the temporary communication group through the long connection.

Because the business client and the voice service client are two separate and independent clients, before the business client exits, when the user starts the group communication through the voice service client, the business client can identify the user currently speaking on its business display interface, such that the users in the temporary communication group can clearly tell which user is currently speaking. After the business client exits, the user can still communicate with users in the communication group via the voice service client, and can also display the account information for each user in the temporary communication group on the voice service interface of the voice service client, such that the users can distinguish other users in temporary communication group.

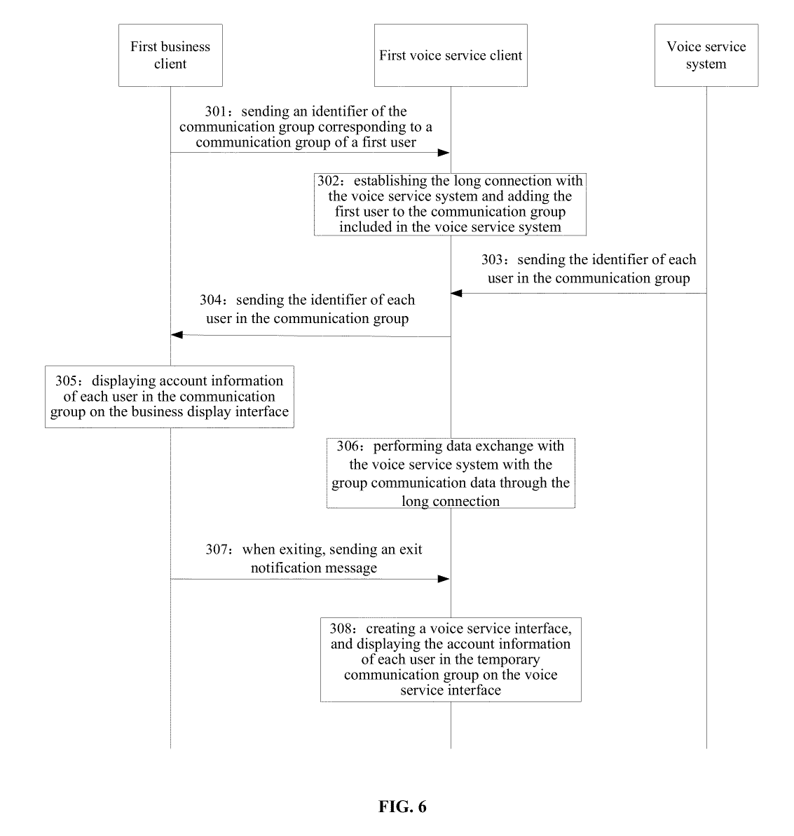

FIG. 6 illustrates another exemplary group communication data exchange process consistent with the disclosed embodiments. A first user uses the business (i.e., business services) via a first business client and, during the use of the business, selects to enter a user group. The user group includes other users in addition to the first user, and the user relationship in the user group is a fixed user relationship, and the user group still exists when the first user exits the user group. The first user conducts group communication (e.g., group chat or group calls) with the other users in the user group while using the business through the first business client.

As shown in FIG. 6, the group communication data exchange process may include the following steps.

Step 301: a first business client sends an identifier of the communication group corresponding to a communication group including a first user to a first voice service client.

Specifically, when a first user needs to conduct group communication with other users in a user group, the first business client receives a communication command submitted by the first user, and establishes a communication channel between the first business client and a first voice service client. Further, using the communication channel between the first business client and the first voice service client, the first business client sends the ID of the communication group corresponding to the user group including the first user to the first voice service client.

In certain embodiments, the first business client may have a business display interface containing a communications command button. When the first user needs to conduct group communication with other users in the user group, the first user can submit the communication command to the first business client by pressing or clicking on the communications command button.

The first voice service client may be started in various ways. For example, two ways may be used to start the first voice service client. First, when the first business client receives the communication command submitted by the first user, the first business client starts the first voice service client. Second, when the first user needs to conduct group communication with other users in the user group, the first user starts the first voice service client.

In certain embodiments, the business may be computer gaming, the business client may be a gaming client, and the communication group may be a fixed chat room.

Step 302: the first voice service client establishes the long connection between the first voice service client and the voice service system based on the identifier of the communication group, and the first user is added into the communication group included in the voice service system.

Specifically, based on the identifier of the communication group, the first voice service client establishes the long connection between the first voice service client and the voice service system, and sends the identifier of the communication group to the voice service system through the long connection. Based on the identifier of the communication group, the voice service system obtains the communication group and adds the first user to the communication group.

When adding the first user to the communication group, the voice service system may add the identifier of the first user to the communication group.

Step 303: based on the identifier of the communication group, the voice service system obtains the identifier of each user in the communication group, and sends the identifier of each user in the communication group to the first voice service client.

Specifically, based on the identifier of the communication group, the voice service system obtains the identifier of each user in the communication group from the pre-stored correspondence relationships between the identifier of the communication group and the identifier of users, and sends the identifier of each user in the communication group to the first voice service client through the long connection between the first voice service client and the voice service system.

Further, the voice service system sends the identifier of each user in the communication group to the second voice service client through the long connection between the second voice service client and the voice service system.

Step 304: the first voice service client receives the identifier of each user in the communication group sent by the voice service system, and sends the identifier of each user in the communication group to the first business client.

Specifically, after the first voice service client receives the identifier of each user in the communication group sent by the voice service system, and sends the identifier of each user in the communication group to the first business client through the communication channel between the first voice service client and the first business client.

Step 305: based on the identifier of each user in the communication group, the first business client displays account information of each user in the communication group on the business display interface of the first business client.

The account information of a user may include any appropriate information. For example, the user account information may include the user's identifier and/or the user's nickname, or may include the user's avatar or other image. When the user account information includes the identifier of the user, the first business client directly displays the identifier of each user in the communication group on the business display interface of the first business client. When the user account information includes the nickname of the user, the first business client obtains the account information of each user in the communication group from pre-stored corresponding relationship between the user identifier and the account information, based on the identifier of each user in the communication group, and further displays the account information of each user in the communication group on the business display interface of the first business client.

Further, similarly, a second business client corresponding to a second user (in addition to the first user) in the communication group may also display the account information of each user in the communication group on its business display interface. The detailed descriptions are omitted herein.

Step 306: the first voice service client performs data exchange with the voice service system with the group communication data generated by the communication group through the long connection between the voice service system and the first voice service client.

The group communication data generated by the communication group may include the voice signal from the first user received by the first voice service client and the first voice data created based on the first user's voice signal. Or the group communication data may also include the voice signal from the second user in the communication group received by the second voice service client and the second voice data created based on the second user's voice signal.

When the first user speaks, the first voice service client receives the voice signals generated by the first user's speech, and converts the speech (voice signal) into the first voice data. The first voice service client further adds the identifier (ID) of the first user in the first voice data, and sends the first voice data to the voice service system through the long connection between the voice service system and the first voice service client.

The voice service system receives the first voice data, and extracts the ID of the first user from the first user voice data. The voice service system also obtains the communication group of the first user based on the ID of the first user, and broadcasts the first voice data to the voice service clients corresponding to the other users in the communication group except the first user. For example, the voice service system broadcasts the first voice data to the second voice service client corresponding to the second user in the communication group, and the second voice service client plays back the first voice data.

When the second user speaks, the second voice service client receives the voice signals generated by the second user's speech, and converts the speech (voice signal) into the second voice data. The second voice service client further adds the identifier (ID) of the second user in the second voice data, and sends the second voice data to the voice service system through the long connection between the voice service system and the second voice service client.

The voice service system receives the second voice data, and extracts the ID of the second user from the second user voice data. The voice service system also obtains the communication group of the second user based on the ID of the second user, and broadcasts the second voice data to the voice service clients corresponding to the other users in the communication group except the second user. For example, the voice service system broadcasts the second voice data to the first voice service client corresponding to the first user in the communication group, and the first voice service client plays back the second voice data.

The first voice service client may receive the second voice data through the long connection between the voice service system and the first voice service client, and plays back according to the second voice data.

Further, the first voice service client extracts the ID of the second user from the received second voice data, and sends the ID of the second user to the first business client through the communication channel between the first voice service client and the first business client.

After receiving the ID of the second user, the first business client identifies or marks the account information of the second user on the business display interface.

Step 307: when the first business client exits, the first business client sends an exit notification message to the first voice service client, and the exit notification message includes the account information of each user in the temporary communication group.

Step 308: the first voice service client receives the exit notification messages, creates a voice service interface, and displays the account information of each user in the temporary communication group on the voice service interface.

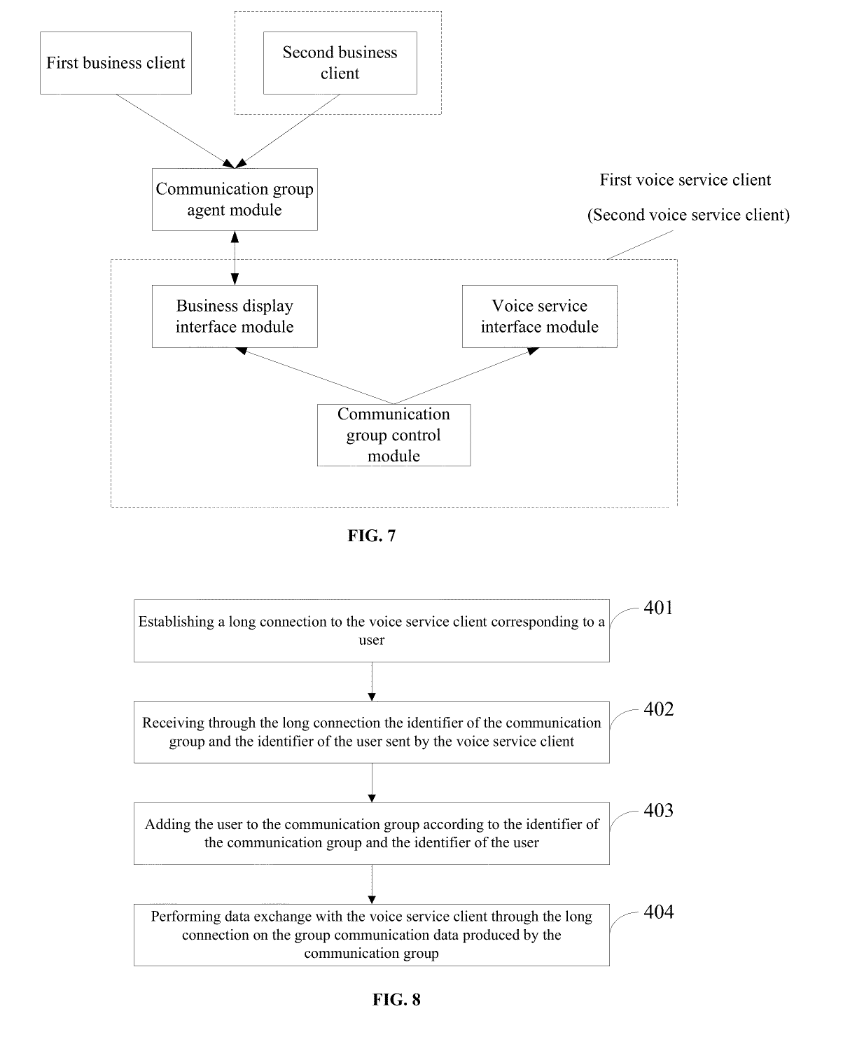

FIG. 7 illustrates a corresponding group communication data exchange structure. As shown in FIG. 7, the data exchange structure includes a communication group control module, a business display interface module, a voice service interface module, a communication group agent module, a first business client, and a second business client.

When the first business client and the second business client perform group communication, the communication group agent module sends the ID of the first user corresponding to the first business client, the ID of the second user corresponding to the second business client, and the ID of the communication group to the first voice service client and the second voice service client (because the first voice service client and the second voice service client have the same structure, only one of the first voice service client and the second voice service client is shown in FIG. 7).

The communication group control module in the first voice service client determines whether the first business client is still running. When the first business client is still running, the ID of the first user and the ID of the second user are displayed on the business display interface. When the first business client has existed, the ID of the first user and the ID of the second user are displayed on the voice service interface.

Further, the communication group control module in the second voice service client determines whether the second business client is still running. When the second business client is still running, the ID of the first user and the ID of the second user are displayed on the business display interface. When the second business client has existed, the ID of the first user and the ID of the second user are displayed on the voice service interface.

More particularly, when a business client exits, the communication group control module obtains the ID of the first user and the ID of the second user on the business display interface, and displays the ID of the first user and the ID of the second user on the voice service interface.

Thus, according to the disclosed embodiments, when a user starts a group communication, the business client sends the ID of the communication group corresponding to the user group where the user belongs to the voice service client. The voice service client establishes a long connection between the voice service client and the voice service system, and the user is added the communication group in the voice service system. The voice service client then performs data exchange with the group communication data produced by the communication group through the long connection.

Because the business client and the voice service client are two separate and independent clients, before the business client exits, when the user starts the group communication through the voice service client, the business client can identify the user currently speaking on its business display interface, such that the users in the communication group can clearly tell which user is currently speaking. After the business client exits, the user can still communicate with users in the communication group via the voice service client, and can also display the account information for each user in the communication group on the voice service interface of the voice service client, such that the users can distinguish other users in communication group.

FIG. 8 illustrates another exemplary group communication data exchange process consistent with the disclosed embodiments. As shown in FIG. 8, the group communication data exchange process may include the following steps.

Step 401: establishing a long connection to the voice service client corresponding to a user.

Step 402: receiving through the long connection the identifier of the communication group and the identifier of the user sent by the voice service client. The identifier of the communication group is the identifier of the communication group sent by the business client and the communication group is the communication group corresponds to the user group where the user belongs.

Step 403: adding the user to the communication group according to the identifier of the communication group and the identifier of the user.

Step 404: performing data exchange with the voice service client through the long connection on the group communication data produced by the communication group.

The above process may be implemented in a voice service system (e.g., a voice server). Thus, according to the disclosed embodiments, when the user requests a group communication, the voice service client establishes a long connection between the voice service client and the voice service system, and the voice service client sends to the voice service system with the identifier of the communication group received from the business client. The voice service system adds the user to the communication group, and performs data exchange with the voice service client over the long connection on the group communication data produced by the communication group. Because the business client and the voice service client are two independent clients, even after the user exits the business client, the user can still communicate with other users in the communication group through the voice service client.

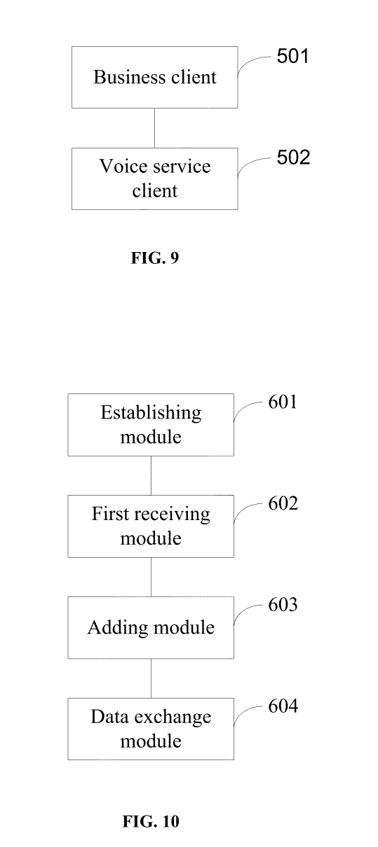

FIG. 9 illustrates an exemplary group communication data exchange system consistent with the disclosed embodiments. The group communication data exchange system may be implemented on a terminal to be used by a user.

As shown in FIG. 9, the group communication data exchange system may include a business client 501 and a voice service client 502. The business client 501 is configured to send to the voice service client 502 with an identifier of the communication group corresponding to a communication group including the user.

The voice service client 502 is configured to, according to the identifier of the communication group, establish a long connection to a voice service system and to add the user in the communication group in the voice service system. The voice service client 502 is further configured to perform data exchange with the voice service system on group communication data generated by the communication group through the long connection.

The business client 501 is also configured to establish a communication channel with the voice service clients. The business client 501 is also configured to send to the voice service client with the identifier of the communication group corresponding to the user group where the user belongs through the communication channel.

Further, the voice service client 502 is configured to receive the identifier of each user in the communication group sent by the voice service system, and to send the identifier of each user in the communication group to the business client 501. The business client 501 is also configured to, based on the identifier of each user in the communication group, respectively obtain account information of each user in the communication group and to display the account information of each user in the communication group on the business display interface of the business client.

Further, the voice service client 502 is configured to receive group communication data produced by the communication group and sent from the voice service system, to extract the identifier of a related user from the received group communication data, and to send the extracted user ID to the business client 501. The business client 501 is also configured to, based on the extracted user ID, identify the account information of the user corresponding to the extracted user ID on the business display interface.

The business client 501 is also configured to, when exiting, send an exit notification message to the voice service client. The exit notification message includes the account information of each user in the communication group. The voice service client 502 is configured to create a voice service interface and to display the account information of each user in the temporary communication group on the voice service interface.

In one embodiment, the user group where the user belongs is a temporary user group. The business client 501 is configured to send a temporary communication request message to the voice service client 502 through a communication channel with the voice service client 502. The voice service client 502 is configured to receive the temporary communication request message, to establishes a long connection (or persistent connection) with the voice service system, and to send the temporary communications request message to the voice service system via the long connection, such that the voice service system assigns a temporary communication group and adds the user to the temporary communication group.

The voice service client 502 is also configured to perform data exchange with the voice service system with the group communication data generated by the temporary communication group through the long connection.

FIG. 10 illustrates an exemplary group communication data exchange device consistent with the disclosed embodiments. The group communication data exchange device may be implemented on a voice server.

As shown in FIG. 10, the group communication data exchange device may include an establishing module 601, a first receiving module 602, an adding module 603, and a data exchange module 604. Other modules may also be included.

The establishing module 601 is configured to establish a long connection to a voice service client corresponding to a user. The first receiving module 602 is configured to receive through the long connection the identifier of the communication group and the identifier of the user sent by the voice service client. The identifier of the communication group is the identifier of the communication group sent by the business client and the communication group is the communication group corresponds to the user group where the user belongs.

Further, the adding module 603 is configured to add the user to the communication group according to the identifier of the communication group and the identifier of the user. The data exchange module 604 is configured to perform data exchange with the voice service client through the long connection on the group communication data produced by the communication group.

Further, the group communication data exchange device also includes an obtaining module (not shown). The obtaining module is configured to obtain the identifier of each user in the communication group based on the identifier of the communication group.

The group communication data exchange device also includes a first transmitting module (not shown). The transmitting module is configured to send the identifier of each user in the communication group to the voice service client through the long connection, such that the voice service client displays the identifier of each user in the communication group. The user group may be the temporary user group and the communication group may be a temporary communication group.

Further, the group communication data exchange device also includes a second receiving module (not shown). The second receiving module is configured to receive the temporary communication request message sent from the voice service client corresponding to another user, and the temporary communication request message includes the identifier of the another user.

The group communication data exchange device also includes a second transmitting module (not shown). The second transmitting module is configured to assign the temporary communication group, to add the another user to the temporary communication group, and to send the identifier of the temporary communication group to business clients corresponding individual users in the temporary user group.

It should be noted that the above units are used for illustrative purposes, and the functions of the units may be realized in one or more such units or additional units. Further, those skilled in the art should understand that all or part of the steps in the above method may be executed by relevant hardware instructed by a program, and the program may be stored in a computer-readable storage medium such as a read only memory, a magnetic disk, a Compact Disc (CD), and so on.

The embodiments disclosed herein are exemplary only and not limiting the scope of this disclosure. Without departing from the spirit and scope of this invention, other modifications, equivalents, or improvements to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed methods and systems, various voice-based group communication applications may be implemented. For example, when the user requests a group communication, the voice service client establishes a long connection between the voice service client and the voice service system, and the voice service client sends to the voice service system with the identifier of the communication group received from the business client. The voice service system adds the user to the communication group, and performs data exchange with the voice service client over the long connection on the group communication data produced by the communication group.

Because the business client and the voice service client are two separate and independent clients, before the business client exits, when the user starts the group communication through the voice service client, the business client can identify the user currently speaking on its business display interface, such that the users in the temporary communication group can clearly tell which user is currently speaking. After the business client exits, the user can still communicate with users in the communication group via the voice service client, and can also display the account information for each user in the temporary communication group on the voice service interface of the voice service client, such that the users can distinguish other users in temporary communication group.

What is claimed is:

1. A method for group communication data exchange, comprising:
sending, by a business client, an identifier of a communication group corresponding to a user group including a first user to a voice service client;
establishing, by the voice service client, a long connection between the voice service client and a voice service system based on the identifier of the communication group;
adding, by the voice service system, the user to a communication group included in the voice service system;
performing, by the voice service client, data exchange with the voice service system over the long connection for group communication data generated by the communication group.

2. The method according to claim 1, wherein sending an identifier of a communication group corresponding to a user group further includes:
establishing, by the business client, a communication channel between the business client and the voice service client; and
sending, by the business client, the identifier of the communication group corresponding to the user group including the first user to the voice service client through the communication channel between the business client and the voice service client.

3. The method according to claim 1, further including:
receiving, by the voice service client, an identifier of each user in the communication group sent by the voice service system;
sending, by the voice service client, the identifier of each user in the communication group to the business client;
obtaining, by the business client, account information of each user in the communication group based on the identifier of each user in the communication group; and
displaying, by the business client, the account information of each user in the communication group on a business display interface of the business client.

4. The method according to claim 3, further including:
receiving, by the voice service client, group communication data generated by the communication group;
extracting, by the voice service client, an identifier of a user in the group communication data;
sending, by the voice service client, the extracted identifier of the user in the group communication data to the business client;
based on the identifier of the user, identifying, by the business client, account information of the user corresponding to the identifier of the user on the business display interface.

5. The method according to claim 1, further including:
sending, by the business client, an exit notification message to the voice service client when exiting, wherein the exit notification message includes account information of each user in the communication group;
creating, by the voice service client, an voice service interface; and
displaying, by the voice service client, the account information of each user in the communication group on the voice service interface.

6. The method according to claim 1, wherein the user group is a temporary user group, before sending the identifier of the communication group to the voice service client, the method further includes:
establishing, by the business client, a communication channel between the business client and the voice service client; and
sending, by the business client, a temporary communication request message to the voice service client through the communication channel between the business client and the voice service client;
receiving, by the voice service client, the temporary communication request message;
establishing, by the voice service client, the long connection between the voice service client and a voice service system;
sending, by the voice service client, the identifier of the user to the voice service system such that the voice service system assigns a temporary communication group and adds the user to the temporary communication group; and
performing, by the voice service client, data exchange with the voice service system over the long connection for group communication data generated by the temporary communication group.

7. A method for group communication data exchange, comprising:
establishing a long connection with a voice service client corresponding to a user;
receiving through the long connection an identifier of a communication group and an identifier of the user sent from the voice service client, wherein the identifier of the communication group is the identifier of the communication group sent by the business client and the communication group is a communication group corresponds to a user group where the user belongs;
based on the identifier of the communication group and the identifier of the user, adding the user to the communication group;
performing data exchange with the voice service client through the long connection with group communication data produced by the communication group.

8. The method according to claim 7, further including:
based on the identifier of the communication group, obtaining identifier of each user in the communication group; and
sending through the long connection the identifier of each user in the communication group to the voice service client, such that the voice service client displays e identifier of each user in the communication group on its business display interface.

9. The method according to claim 7, wherein the user group is a temporary user group and the communication group is a temporary communication group, before establishing the long connection, the method further includes:
receiving a temporary communication request message from a voice service client corresponding to a first user, wherein the temporary communication request message includes an identifier of the first user and the first user is another user in the temporary user group;
assigning the temporary communication group;
adding the first user to the temporary communication group; and
sending the identifier of the temporary communication group to business client corresponding to each user in the temporary communication group.

10. A group communication data exchange system, comprising:
a business client; and
a voice service client,
wherein the business client is configured to send an identifier of a communication group corresponding to a user group including a first user to the voice service client,
the voice service client is configured to, based on the identifier of the communication group, establish a long connection between the voice service client and a voice service system and to add the user to a communication group included in a voice service system;
the voice service client is further configured to perform data exchange with the voice service system over the long connection with group communication data generated by the communication group.

11. The system according to claim 10, wherein the business client is further configured to:
establish a communication channel between the business client and the voice service client; and
send the identifier of the communication group corresponding to the user group including the first user to the voice service client through the communication channel between the business client and the voice service client.

12. The system according to claim 10, wherein:
the voice service client is further configured to receive an identifier of each user in the communication group sent by the voice service system and to send the identifier of each user in the communication group to the business client;
the business client is further configured to obtain account information of each user in the communication group based on the identifier of each user in the communication group and to display the account information of each user in the communication group on a business display interface of the business client.

13. The system according to claim 12, wherein:
the voice service client is further configured to receive group communication data generated by the communication group, to extract an identifier of a user in the group communication data, and to send the extracted identifier of the user in the group communication data to the business client; and
the business client is further configured to, based on the identifier of the user, identify account information of the user corresponding to the identifier of the user on the business display interface.

14. The system according to claim 10, wherein:
the business client is further configured to send an exit notification message to the voice service client when exiting, wherein the exit notification message includes account information of each user in the communication group; and
the voice service client is further configured to create a voice service interface and to display the account information of each user in the communication group on the voice service interface.

15. The system according to claim 10, wherein, before sending the identifier of the communication group to the voice service client, the method further includes:
the user group is a temporary user group;
the business client is further configured to establish a communication channel between the business client and the voice service client and to send a temporary communication request message to the voice service client through the communication channel between the business client and the voice service client;
the voice service client is further configured to receive the temporary communication request message, to establish the long connection between the voice service client and a voice service system, and to send the identifier of the user to the voice service system such that the voice service system assigns a temporary communication group and adds the user to the temporary communication group; and
the voice service client is further configured to perform data exchange with the voice service system over the long connection for group communication data generated by the temporary communication group.

16. A group communication data exchange device, comprising:
an establishing module configured to establish a long connection with a voice service client corresponding to a user;
a first receiving module configured to receive through the long connection an identifier of a communication group and an identifier of the user sent from the voice service client, wherein the identifier of the communication group is the identifier of the communication group sent by the business client and the communication group is a communication group corresponds to a user group where the user belongs;
an adding module configured to, based on the identifier of the communication group and the identifier of the user, add the user to the communication group; and
a data exchange module configured to perform data exchange with the voice service client through the long connection with group communication data produced by the communication group.

17. The system according to claim 16, further including:
an obtaining module configured to, based on the identifier of the communication group, obtain identifier of each user in the communication group; and
a first transmitting module configured to send through the long connection the identifier of each user in the communication group to the voice service client, such that the voice service client displays e identifier of each user in the communication group on its business display interface.

18. The system according to claim 16, wherein the user group is a temporary user group and the communication group is a temporary communication group, the system further includes:
a second receiving module configured to receive a temporary communication request message from a voice service client corresponding to a first user, wherein the temporary communication request message includes an identifier of the first user and the first user is another user in the temporary user group;
a second transmitting module configured to assign the temporary communication group, to add the first user to the temporary communication group, and to send the identifier of the temporary communication group to business client corresponding to each user in the temporary communication group.
